(19) United States
(12) Patent Application Publication
(10) Pub. No.: US 2026/0231987 A1
(43) Pub. Date: Aug. 13, 2026

(54) CARBONATED BEVERAGE CONTAINING FRUIT PIECES, APPARATUS FOR MANUFACTURING CARBONATED BEVERAGE, AND METHOD FOR MANUFACTURING CARBONATED BEVERAGE USING THE SAME

(71) Applicant: Pyung-Sik HAN, Seoul (KR)

(72) Inventor: Pyung-Sik HAN, Seoul (KR)

(21) Appl. No.: 19/533,834

(22) Filed: Feb. 9, 2026

(30) Foreign Application Priority Data
Feb. 11, 2025 (KR) 10-2025-0017571

(51) Int. Cl. A23L 2/54; A23L 2/38; B01F 23/236; B01F 23/2361; B01F 23/237; B01F 101/14

(52) U.S. Cl. CPC A23L 2/54; A23L 2/38; B01F 23/2361; B01F 23/2363; B01F 23/237621; B01F 2101/14

(57) ABSTRACT

Provided are an apparatus for manufacturing a carbonated beverage containing fruit pieces configured to heat-sterilize and cool fruit pieces and mix the fruit pieces with carbonated water, and a method for manufacturing a carbonated beverage using the same.

The apparatus includes a heating device configured to heat-sterilize a can containing fruit pieces, a cooling device configured to cool the can having passed through the heating device, and a filler configured to inject carbon dioxide gas into the can having passed through the cooling device, wherein the cooling device includes a cooling water spraying unit configured to spray cooling water onto the can, and a nitrogen gas spraying unit configured to spray nitrogen gas into the can.

### TECHNICAL FIELD

The present invention relates to a carbonated beverage containing fruit pieces, an apparatus for manufacturing a carbonated beverage, and a method for manufacturing a carbonated beverage using the same, and more particularly, to a carbonated beverage containing fruit pieces, an apparatus for manufacturing a carbonated beverage, and a method for manufacturing a carbonated beverage using the same, which are configured to heat-sterilize and cool fruit pieces and mix the fruit pieces with carbonated water.

### BACKGROUND OF THE INVENTION

Recently, consumer consumption patterns are changing toward health-oriented products equipped with functionality and safety. Accordingly, in the food industry, development of health-oriented materials and research on various types of processed products are actively being conducted.

In particular, among health-oriented processed products, health beverages are products consumed by consumers based on convenience, palatability, and functionality. It is known that consumers utilize nutritional ingredients having physiological activity as a very important selection factor in the process of selecting a beverage.

It is known that fruits and vegetables, which are the main raw materials of health beverages, are rich in phenolic compounds, antioxidant vitamins, and the like, and these components have been studied to reduce oxidative stress in the body. Accordingly, food companies are continuously releasing health beverages containing functional materials such as fruits and vegetables.

Most carbonated beverages are manufactured as products by adding fruit flavors or fruit juice due to manufacturing costs, and the amount of fruit juice added to these products is very small, at around 10%.

Meanwhile, NFC (Not From Concentrate) beverages, which are beverages using only fruit juice obtained by squeezing fruits without concentration of raw materials and addition of water, are increasing according to consumption trends.

However, carbonated beverages made from fruit juice are prone to fermentation or deterioration due to microorganisms and enzymes in the fruit when stored at room temperature for a long period of time. Therefore, to improve this, the acidity of the carbonated beverage can be reduced and the pigments in the fruit juice can be faded through a treatment process such as adding food additives.

Therefore, there is a need for development and research of a carbonated beverage containing fruit pieces rather than fruit juice. However, fruit pieces are vulnerable to microbial contamination, which may be a factor that hinders the safety of a finished product. Accordingly, in order to manufacture a carbonated beverage containing fruit pieces, a technology for effectively controlling microorganisms in the fruit pieces may be required.

### SUMMARY OF THE INVENTION

### Technical Problem

An objective of the present invention is to effectively prevent microbial contamination of fruit pieces included in a carbonated beverage to secure product safety.

Another objective of the present invention is to maintain the concentration of carbonic acid by suppressing vaporization of carbon dioxide gas due to an internal temperature rise of a can when filling carbonated water into the can, and to prevent overflowing of a mixed liquid due to foaming.

### Solution to the Problem

An apparatus for manufacturing a carbonated beverage containing fruit pieces according to the present invention includes a heating device configured to heat-sterilize a can containing fruit pieces, a cooling device configured to cool the can having passed through the heating device, and a filler configured to inject carbon dioxide gas into the can having passed through the cooling device, wherein the cooling device may include a cooling water spraying unit configured to spray cooling water onto the can, and a nitrogen gas spraying unit configured to spray nitrogen gas into the can.

In addition, the cooling water spraying unit may be configured to spray cooling water to the outside of the can, and the nitrogen gas spraying unit may be configured to spray nitrogen gas into the inside of the can.

In addition, the cooling water spraying unit may include a plurality of cooling water spraying pipes respectively disposed along a traveling direction of the conveyor near both sides of a conveyor conveying the can so as to cool both side surfaces of the can, and the plurality of cooling water spraying pipes may include a plurality of cooling water spraying nozzles disposed to be spaced apart along the traveling direction of the conveyor.

In addition, the nitrogen gas spraying unit may include a nitrogen gas spraying pipe disposed at an upper portion of the can conveyed along the conveyor so as to cool the inside of the can.

In addition, the heating device may include a tunnel structure configured to heat-sterilize the can containing the fruit pieces introduced into and discharged from the heating device through steam.

In addition, the cooling device may further include a foreign matter prevention unit disposed at an upper portion of the conveyor so as to prevent foreign matter from penetrating into the inside of the can, and the foreign matter prevention unit may be disposed to be connected to both side surfaces of the nitrogen gas spraying unit along the traveling direction of the conveyor.

The cooling device may further include a water collecting unit disposed at a lower portion of the conveyor so as to store the cooling water sprayed from the cooling water spraying unit, and the water collecting unit may include a discharge part configured to discharge the cooling water stored in the water collecting unit to a lower portion of the water collecting unit.

In addition, the cooling water spraying unit may further include a plurality of adjustment brackets disposed on both sides of the conveyor so as to adjust heights of the plurality of cooling water spraying pipes according to a height of the can.

In addition, the conveyor may include a straight rail and a curved rail extending from the straight rail, and the cooling device may be disposed along the straight rail.

In addition, the straight rail may include a first straight rail connected to the heating device, and a second straight rail disposed to be spaced apart from the first straight rail along the traveling direction of the conveyor, and the cooling device may further include a first cooling device disposed on the first straight rail, and a second cooling device disposed on the second straight rail and having a length along the traveling direction of the conveyor shorter than that of the first cooling device.

In addition, the nitrogen gas spraying unit may include a first nitrogen gas spraying unit disposed at a rear end portion of the first straight rail along the traveling direction of the conveyor, and a second nitrogen gas spraying unit regularly disposed on the second straight rail.

In another aspect, a method for manufacturing a carbonated beverage containing fruit pieces according to the present invention may include: (a) conveying a can containing the fruit pieces through a conveyor and passing the can through a heating device to heat-sterilize the fruit pieces; (b) cooling the can containing the heat-sterilized fruit pieces through a cooling device; and (c) injecting a mixed liquid containing carbonated water into the can containing the cooled fruit pieces through a filler.

In addition, step (a) may include passing the can containing the fruit pieces through the heating device at 90° C. to 95° C. for 10 minutes to 15 minutes to heat-sterilize the can through steam.

In addition, step (b) may include: (b-1) spraying cooling water onto an outer surface of the can through a cooling water spraying unit; and (b-2) spraying nitrogen gas into the inside of the can through a nitrogen gas spraying unit.

In addition, step (b) may include proceeding with step (b-1), adding step (b-2) while step (b-1) is in progress to proceed with step (b-1) and step (b-2) simultaneously, and terminating step (b-1) and step (b-2) together.

In addition, step (b) may include cooling the can containing the fruit pieces through a first cooling device, and cooling the can containing the fruit pieces through a second cooling device disposed to be spaced apart from the first cooling device along the traveling direction of the conveyor.

In still another aspect, a carbonated beverage containing fruit pieces according to the present invention includes fruit pieces including raw fruit flesh, a can configured to accommodate the fruit pieces, and a mixed liquid containing carbon dioxide gas filled in the can containing the fruit pieces, wherein the fruit pieces may be cooled to prevent the carbon dioxide gas of the mixed liquid filled in the can from being vaporized.

In addition, the fruit pieces may include fruit slices or fruit cubes.

In addition, the fruit pieces may include lemon pieces or grapefruit pieces.

In addition, the mixed liquid may include alcohol to sterilize the fruit pieces included in the can, and the can may include a transparent plastic material.

In addition, the fruit pieces may be heated and then cooled to sterilize microorganisms remaining in the fruit pieces, and the can containing the heated and cooled fruit pieces may include an aluminum material.

In addition, the fruit pieces may be 2 to 3% by weight.

### Advantageous Effects

The carbonated beverage containing fruit pieces, the apparatus for manufacturing a carbonated beverage, and the method for manufacturing a carbonated beverage using the same according to the present invention can improve product safety by effectively sterilizing fruit pieces included in the carbonated beverage to prevent microbial contamination.

The carbonated beverage containing fruit pieces, the apparatus for manufacturing a carbonated beverage, and the method for manufacturing a carbonated beverage using the same according to the present invention can maintain a constant concentration of carbonic acid by suppressing vaporization of carbon dioxide gas due to an internal temperature rise of the can when filling carbonated water into the can, allow injection of high-pressure carbon dioxide gas, and prevent overflowing of the mixed liquid due to foaming.

### BRIEF DESCRIPTION OF THE DRAWINGS

FIG. 1 is a view illustrating an apparatus for manufacturing a carbonated beverage containing fruit pieces according to the present invention.

FIG. 2 is a view illustrating a heating device in the apparatus for manufacturing a carbonated beverage containing fruit pieces according to the present invention.

FIG. 3 is a view illustrating a first cooling device disposed on a first straight rail in the apparatus for manufacturing a carbonated beverage containing fruit pieces according to the present invention.

FIG. 4 is a view illustrating a second cooling device disposed on a second straight rail in the apparatus for manufacturing a carbonated beverage containing fruit pieces according to the present invention.

FIG. 5 is a view illustrating a cooling device viewed along a traveling direction of a conveyor in the apparatus for manufacturing a carbonated beverage containing fruit pieces according to the present invention.

FIG. 6 is a view illustrating steps of a method for manufacturing a carbonated beverage containing fruit pieces according to the present invention.

FIG. 7 is a view specifically illustrating a heating/sterilizing step and a cooling step in the method for manufacturing a carbonated beverage containing fruit pieces according to the present invention.

### DETAILED DESCRIPTION OF THE PREFERRED EMBODIMENTS

The embodiments described in this specification and the configurations illustrated in the drawings are merely preferred examples of the disclosed invention, and various modifications that can replace the embodiments and drawings of the present specification may exist at the time of filing of the present application.

In addition, the same reference numerals or signs presented in each drawing of this specification indicate parts or components that perform substantially the same function. In addition, the terms used in this specification are used to describe the embodiments and are not intended to limit and/or restrict the disclosed invention. Singular expressions include plural expressions unless the context clearly indicates otherwise.

In this specification, terms such as “comprise” or “have” are intended to designate that a feature, number, step, operation, component, part, or combination thereof described in the specification exists, but do not preclude the possibility of the existence or addition of one or more other features, numbers, steps, operations, components, parts, or combinations thereof.

In addition, terms including ordinal numbers such as “first”, “second”, etc. used in this specification may be used to describe various components, but the components are not limited by the terms, and the terms are used only for the purpose of distinguishing one component from another.

Meanwhile, terms such as “front”, “rear”, “upper”, and “lower” used in the following description are defined based on the drawings, and the shape and position of each component are not limited by these terms.

Hereinafter, embodiments according to the present invention will be described in detail with reference to the accompanying drawings.

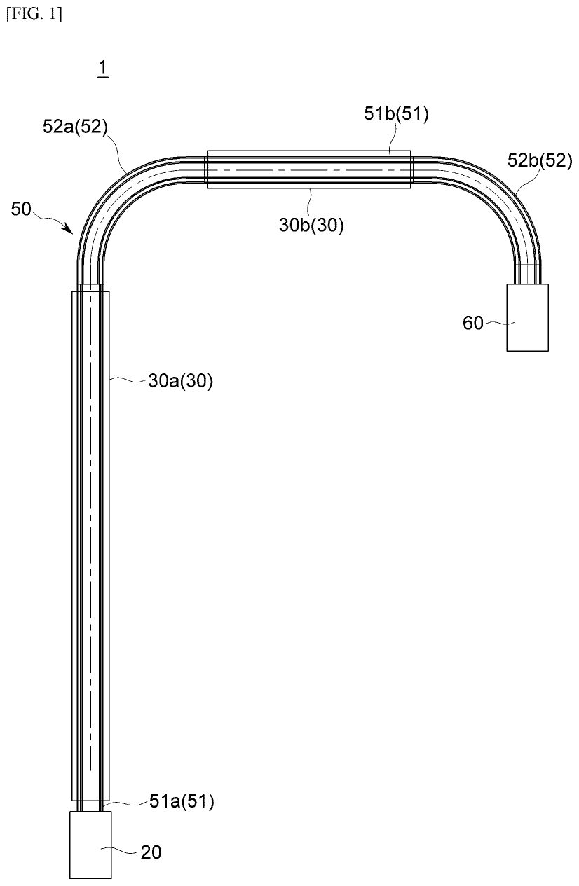

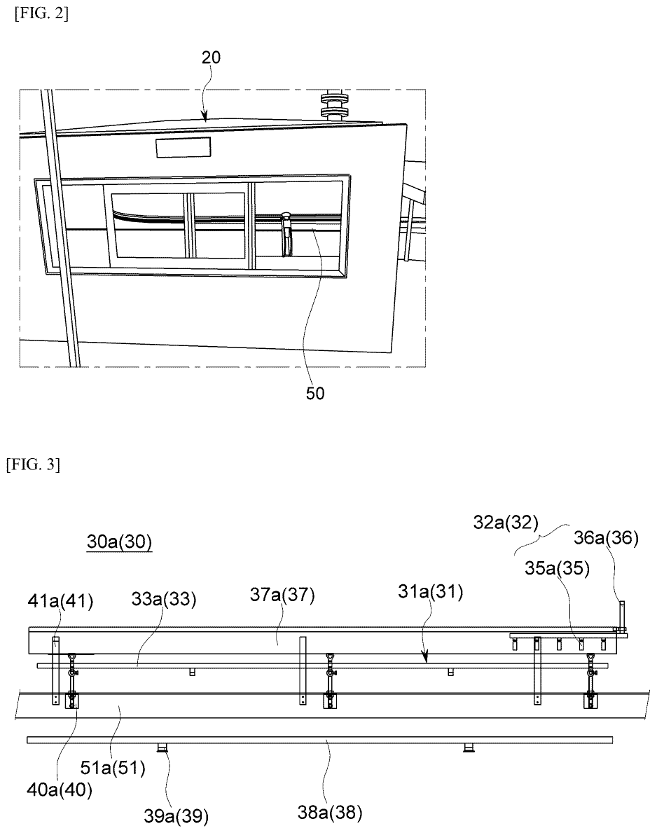

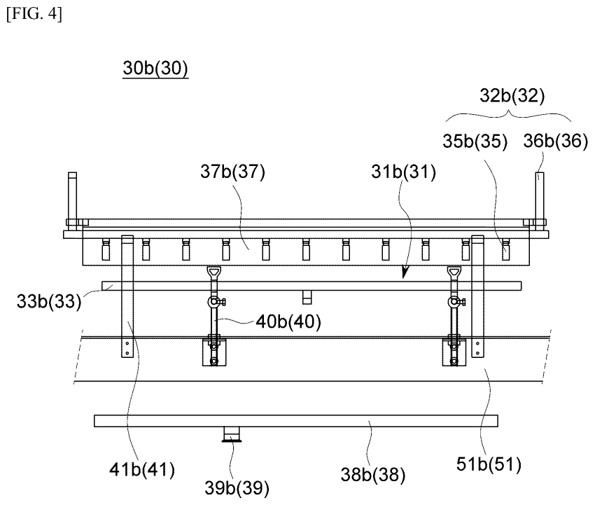

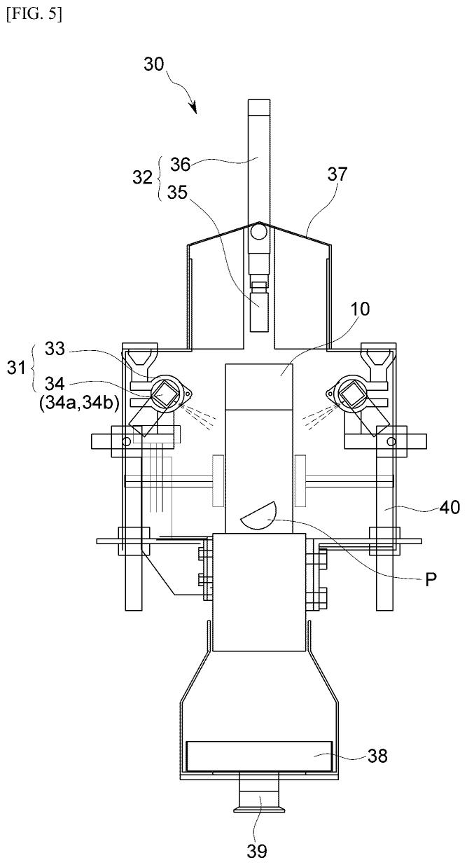

FIG. 1 is a view illustrating an apparatus for manufacturing a carbonated beverage containing fruit pieces according to the present invention. FIG. 2 is a view illustrating a heating device in the apparatus for manufacturing a carbonated beverage containing fruit pieces according to the present invention. FIG. 3 is a view illustrating a first cooling device disposed on a first straight rail in the apparatus for manufacturing a carbonated beverage containing fruit pieces according to the present invention. FIG. 4 is a view illustrating a second cooling device disposed on a second straight rail in the apparatus for manufacturing a carbonated beverage containing fruit pieces according to the present invention. FIG. 5 is a view illustrating a cooling device viewed along a traveling direction of a conveyor in the apparatus for manufacturing a carbonated beverage containing fruit pieces according to the present invention.

Referring to FIGS. 1 to 5, an apparatus 1 for manufacturing a carbonated beverage containing fruit pieces according to the present invention may include a heating device 20 configured to heat-sterilize a can 10 containing fruit pieces P, and a cooling device 30 configured to cool the can 10 containing the fruit pieces P having passed through the heating device 20.

The fruit pieces P may include fruit slices or fruit cubes. The fruit pieces P may include raw fruit flesh. The fruit pieces P may be accommodated inside the can 10 by a manual or automatic process. For example, when the fruit pieces P are fruit slices, the fruit pieces P may be manually accommodated inside the can 10 by a manufacturer, and when the fruit pieces P are fruit cubes, the fruit pieces P may be automatically accommodated inside the can 10 by a device. However, it is not limited thereto.

The apparatus 1 for manufacturing a carbonated beverage containing fruit pieces may include a conveyor 50 configured to transfer the can 10 containing the fruit pieces P, and a filler 60 configured to inject carbon dioxide gas into the can 10 containing the fruit pieces P having passed through the cooling device 30.

The heating device 20 may perform a role of sterilizing microorganisms of the fruit pieces P including raw fruit flesh by heating the can 10 containing the fruit pieces P. The can 10 containing the fruit pieces P may be transferred by the conveyor 50, introduced into the heating device 20, heated and sterilized through the heating device 20, and discharged to the outside of the heating device 20.

The heating device 20 may include a tunnel structure such that the can 10 containing the fruit pieces P is introduced and discharged. However, it is not limited thereto.

In FIG. 2, the heating device 20 is illustrated in a square box shape including an inlet and an outlet along a traveling direction of the conveyor 50, but is not limited thereto, and may include various shapes within a limit in which the can 10 containing the fruit pieces P is transferred along the conveyor 50 and heated and sterilized through the heating device 20.

The heating device 20 may heat and sterilize the can 10 containing the fruit pieces P using steam. However, the present invention is not limited thereto, and the heating device 20 may heat and sterilize the can 10 using hot air or electricity.

The heating device 20 may set an appropriate heating temperature and time according to the type of the fruit pieces P and the material and size of the can 10. For example, when the can 10 is made of an aluminum material and the fruit pieces P are lemon slices, the heating device 20 may heat and sterilize the can 10 containing the fruit pieces P for 10 minutes or more using steam of 90° C. or higher. Preferably, the heating device 20 may heat and sterilize the can 10 containing the fruit pieces P for 10 minutes to 15 minutes using steam of 93° C.±2° C.

The tunnel structure of the heating device 20 may be configured such that the can 10 is exposed to steam and heat-sterilized while passing through the inside of the heating device 20. The length of the tunnel structure of the heating device 20 and the steam injection amount of the heating device 20 may be adjusted in consideration of the size of the can 10, the sterilization temperature, and the sterilization time.

The heating device 20 may include a steam generator (not shown) configured to generate steam, a temperature controller (not shown) for maintaining the temperature inside the tunnel constant, or a steam injection device (not shown) for uniformly injecting steam into the tunnel.

The can 10 containing the fruit pieces P heated and sterilized by the heating device 20 may be configured to be directed toward the cooling device 30 along the conveyor 50.

The fruit pieces P may include raw fruit flesh, and there may be a need to heat and sterilize microorganisms present in the fruit pieces P including the raw fruit flesh in order to be added to the carbonated beverage.

However, when the carbonated beverage is a carbonated beverage containing alcohol such as whiskey, microorganisms present in the fruit pieces P may be sterilized by the alcohol of the whiskey. In this case, the apparatus 1 for manufacturing a carbonated beverage containing fruit pieces may not require a separate heating device 20.

Alternatively, in the case of manufacturing a carbonated beverage containing alcohol such as whiskey, the heating device 20 may not be operated, and thus, the manufacturing time of the carbonated beverage containing the fruit pieces P can be reduced, and the efficiency of the cooling process through the cooling device 30 can be improved.

The cooling device 30 may perform a role of cooling the can 10 containing the fruit pieces P having passed through the heating device 20. Although microorganisms present in the fruit pieces P are sterilized by heating the can 10 containing the fruit pieces P, the temperature of the can 10 containing the fruit pieces P may increase due to this.

In a process of filling carbonated water containing carbon dioxide gas into the can 10 containing the fruit pieces P through the filler 60, there may be a need to lower the temperature of the can 10 containing the fruit pieces P in order to improve solubility of the carbon dioxide gas.

Therefore, before filling the carbonated water into the can 10 containing the fruit pieces P having passed through the heating device 20 through the filler 60, the temperature of the can 10 containing the fruit pieces P may be lowered through the cooling device 30.

The cooling device 30 may include a cooling water spraying unit 31 configured to spray cooling water onto the can 10, and a nitrogen gas spraying unit 32 configured to spray nitrogen gas into the can 10. The cooling device 30 may effectively cool the outside and inside of the can 10 to prevent vaporization of carbon dioxide gas in the carbonated water filled through the filler 60, thereby maintaining the quality of the carbonated beverage containing the fruit pieces P.

The filler 60 may perform a role of completing the manufacture of the carbonated beverage by injecting carbonated water containing carbon dioxide gas into the can 10 requiring the fruit pieces P cooled through the cooling device 30. The filler 60 may precisely control an injection amount of the carbonated water containing carbon dioxide gas to manufacture a carbonated beverage having a desired carbonation concentration.

The cooling water spraying unit 31 may be configured to spray cooling water to the outside of the can 10. The nitrogen gas spraying unit 32 may be configured to spray nitrogen gas into the inside of the can 10.

The cooling water spraying unit 31 may effectively cool the entire temperature of the can 10 by uniformly spraying cooling water onto an outer surface of the can 10. The cooling water spraying unit 31 may include a cooling water spraying pipe 33, a cooling water spraying nozzle 34, and an adjusting bracket 40, and through this, may be configured to adjust a spraying amount and a spraying angle of the cooling water sprayed onto the can 10.

The nitrogen gas spraying unit 32 may lower a temperature inside the can 10 by spraying nitrogen gas into the inside of the can 10, and through this, may perform a role of preventing vaporization of carbon dioxide gas in the carbonated water to be filled through the filler 60.

The nitrogen gas may be uniformly sprayed around the fruit pieces P inside the can 10, and through this, the quality of the carbonated beverage containing the fruit pieces P may be maintained, and the taste and flavor of the carbonated beverage may be preserved.

The nitrogen gas spraying unit 32 may include a nitrogen gas spraying pipe 35 and a nitrogen gas supply pipe 36, and through this, may adjust a spraying amount of nitrogen gas sprayed into the inside of the can 10 containing the fruit pieces P.

The cooling water spraying unit 31 may include cooling water spraying pipes 33 respectively disposed along a traveling direction of the conveyor 50 near both side surfaces of the conveyor 50 conveying the can 10 so as to cool both side surfaces of the can 10.

The cooling water spraying pipe 33 may include a plurality of cooling water spraying pipes 33. The plurality of cooling water spraying pipes 33 may include two cooling water spraying pipes 33 respectively disposed along the traveling direction of the conveyor 50 near both side surfaces of the conveyor 50 conveying the can 10.

The cooling water spraying pipe 33 may include cooling water spraying nozzles 34 disposed to be spaced apart along the traveling direction of the conveyor 50. The cooling water spraying nozzle 34 may include a plurality of cooling water spraying nozzles 34. The plurality of cooling water spraying nozzles 34 may be disposed at regular intervals along a longitudinal direction of the cooling water spraying pipe 33.

The plurality of cooling water spraying nozzles 34 may be disposed to be spaced apart at regular intervals in each of the plurality of cooling water spraying pipes 33. For example, the plurality of cooling water spraying nozzles 34 may be disposed in the cooling water spraying pipe 33 to be spaced apart at intervals of 20 mm. The cooling water spraying nozzle 34 may include a spray hole having a diameter of 1.8 mm. However, it is not limited thereto.

An interval at which the plurality of cooling water spraying nozzles 34 are spaced apart and respective sizes thereof may be configured to be adjustable in consideration of the size of the can 10, the cooling water spraying amount, and a cooling speed.

The cooling water spraying unit 31 may include cooling water spraying nozzles 34 disposed to be inclined toward the side surface of the can 10 near a side surface of the conveyor 50 conveying the can 10 so as to cool the side surface of the can 10. An inclination angle of the cooling water spraying nozzle 34 may be adjusted in consideration of the size of the can 10, the cooling water spraying amount, and the cooling speed.

The nitrogen gas spraying unit 32 may include a nitrogen gas spraying pipe 35 disposed at an upper portion of the can 10 conveyed along the conveyor 50 so as to cool the inside of the can 10. The nitrogen gas spraying pipe 35 may be disposed to face the inside of the can 10 and configured to spray nitrogen gas into the inside of the can 10 containing the fruit pieces P.

The nitrogen gas spraying pipe 35 may include a plurality of nitrogen gas spraying pipes 35. The plurality of nitrogen gas spraying pipes 35 may be disposed at regular intervals. The nitrogen gas spraying pipe 35 may be configured to be disposed along a moving path of the can 10 and continuously spray nitrogen gas into the inside of the can 10 while the can 10 moves along the conveyor 50.

The nitrogen gas spraying pipe 35 is disposed at an upper portion of the can 10 conveyed through the conveyor 50 to directly spray nitrogen gas into the inside of the can 10 containing the fruit pieces P, and through this, the fruit pieces P may be directly cooled by the nitrogen gas.

The apparatus 1 for manufacturing a carbonated beverage containing fruit pieces P according to the present invention may indirectly cool the fruit pieces P by cooling the outside of the can 10 through the cooling water spraying unit 31 while the can 10 containing the fruit pieces P heated and sterilized through the heating device 20 is conveyed along the conveyor 50, and may directly cool the fruit pieces P contained in the inside of the can 10 through the nitrogen gas spraying unit 32.

The nitrogen gas spraying unit 32 may include a nitrogen gas supply pipe 36 for supplying nitrogen gas to the nitrogen gas spraying pipe 35. The nitrogen gas supply pipe 36 may include a plurality of nitrogen gas supply pipes 36. The nitrogen gas supply pipe 36 may be disposed at an upper portion of the nitrogen gas spraying pipe 35. However, it is not limited thereto.

The apparatus 1 for manufacturing a carbonated beverage containing fruit pieces P according to the present invention may include a nitrogen gas connection pipe (not shown) configured to connect the plurality of nitrogen gas spraying pipes 35 and the plurality of nitrogen gas supply pipes 36.

The cooling device 30 may include a foreign matter prevention unit 37 disposed at an upper portion of the conveyor 50 so as to prevent foreign matter from penetrating into the inside of the can 10. The foreign matter prevention unit 37 may be disposed at an upper portion of the can 10.

The foreign matter prevention unit 37 may be configured to be disposed at the upper portion of the conveyor 50 to cover an open upper portion of the can 10. The foreign matter prevention unit 37 may include a cover shape including a curved portion. However, it is not limited thereto.

The foreign matter prevention unit 37 may be disposed to be connected to both side surfaces of the nitrogen gas spraying unit 32 along the traveling direction of the conveyor 50. The foreign matter prevention unit 37 is connected to both side surfaces of the nitrogen gas spraying unit 32 along the traveling direction of the conveyor 50, and may be configured such that the foreign matter prevention unit 37 continuously covers the upper portion of the can 10 while the can 10 moves along the conveyor 50.

The upper portion of the can 10 may be open so that nitrogen gas sprayed from the nitrogen gas spraying pipe 35 for directly cooling the inside of the can 10 containing the fruit pieces P is introduced into the inside of the can 10, and the open upper portion of the can 10 may be covered through the foreign matter prevention unit 37.

The foreign matter prevention unit 37 may be disposed to be elongated along the traveling direction of the conveyor 50 where the cooling device 30 is disposed.

The cooling device 30 may include a water collecting unit 38 disposed at a lower portion of the conveyor 50 so as to store cooling water sprayed from the cooling water spraying unit 31. The water collecting unit 38 is disposed at the lower portion of the conveyor 50 and may collect cooling water sprayed from the cooling water spraying unit 31 to cool the outside of the can 10.

The water collecting unit 38 may be disposed at a lower portion of the can 10. The water collecting unit 38 may be disposed to be elongated along the traveling direction of the conveyor 50 where the cooling device 30 is disposed.

The water collecting unit 38 may include a discharge unit 39 configured to discharge the cooling water stored in the water collecting unit 38 to a lower portion of the water collecting unit 38. The discharge unit 39 may be configured to be disposed at the lower portion of the water collecting unit 38 so that the cooling water is discharged by gravity. The cooling water discharged to the outside of the water collecting unit 38 through the discharge unit 39 may be recycled or discarded.

The cooling water spraying unit 31 may include a plurality of adjusting brackets 40 disposed on both sides of the conveyor 50 so as to adjust heights of the plurality of cooling water spraying pipes 33 according to a height of the can 10.

The adjusting bracket 40 may be configured to adjust the height of the cooling water spraying pipe 33 to change a cooling water spraying height according to a size of the can 10.

The adjusting brackets 40 may be disposed on both sides of the conveyor 50 to stably support the cooling water spraying pipe 33 and to be configured to adjust the height thereof. The adjusting bracket 40 may be adjusted manually or automatically, and may be configured to automatically adjust the height of the cooling water spraying pipe 33 in conjunction with a separate sensor (not shown) detecting the height of the can 10. However, it is not limited thereto.

One end of the adjustment bracket 40 can be connected to the lower part of the conveyor 50, and the other end of the adjustment bracket 40 can be connected to the foreign matter prevention unit 37. The cooling water spraying pipe 33 is disposed to be movable between the one end and the other end of the adjusting bracket 40 to adjust a height for spraying the cooling water according to the height of the can 10.

The adjusting bracket 40 may include a plurality of adjusting brackets 40. The plurality of adjusting brackets 40 may be disposed in plural numbers on both sides of the conveyor 50, respectively. The plurality of adjusting brackets 40 disposed on both sides of the conveyor 50 may be disposed in plural numbers on one side of the conveyor 50, respectively. However, it is not limited thereto.

The apparatus 1 for manufacturing a carbonated beverage containing fruit pieces P according to the present invention may include a fixing bracket 41 fixedly fastened to the lower portion of the conveyor 50 so as to fasten the nitrogen gas spraying unit 32 and the foreign matter prevention unit 37 disposed on the upper portion of the conveyor 50 together with the adjusting bracket 40.

The fixing bracket 41 may include a plurality of fixing brackets 41. The fixing bracket 41 may be disposed adjacent to the adjusting bracket 40. One end of the fixing bracket 41 may be fastened to the lower portion of the conveyor 50, and the other end of the fixing bracket 41 may be fastened to the foreign matter prevention unit 37. However, it is not limited thereto.

The conveyor 50 may include a straight rail 51 and a curved rail 52 extending from the straight rail 51. The cooling device 30 of the apparatus 1 for manufacturing a carbonated beverage containing fruit pieces P according to the present invention may be disposed along the straight rail 51.

The straight rail 51 may be used to convey the can 10 in a constant direction, and the curved rail 52 may be used to change a conveying direction of the can 10. However, it is not limited thereto.

The straight rail 51 may include a first straight rail 51a connected to the heating device 20, and a second straight rail 51b disposed to be spaced apart from the first straight rail 51a along the traveling direction of the conveyor 50.

The curved rail 52 may include a first curved rail 52a disposed between the first straight rail 51a and the second straight rail 51b, and a second curved rail 52b disposed between the second straight rail 51b and the filler 60.

The first straight rail 51a may be longer than the second straight rail 51b. For example, a length of the first straight rail 51a may be 2500 mm to 3000 mm, and a length of the second straight rail 51b may be 1000 mm to 1500 mm. Preferably, the length of the first straight rail 51a may be 2720 mm, and the length of the second straight rail 51b may be 1100 mm. However, it is not limited thereto.

A radius of curvature of the curved rail 52 may be 400 mm to 600 mm. Preferably, the radius of curvature of the curved rail 52 may be 500 mm. The first curved rail 52a and the second curved rail 52b may be disposed to face each other. However, it is not limited thereto.

The cooling device 30 may include a first cooling device 30a disposed on the first straight rail 51a, and a second cooling device 30b disposed on the second straight rail 51b. A length of the second cooling device 30b along the traveling direction of the conveyor 50 may be shorter than a length of the first cooling device 30a.

The length of the first cooling device 30a may be 2500 mm to 2800 mm. The length of the second cooling device 30b may be 1000 mm to 1200 mm. Preferably, the length of the first cooling device 30a may be 2650 mm, and the length of the second cooling device 30b may be 1080 mm.

Accordingly, the can 10 containing the fruit pieces P conveyed along the conveyor 50 may be cooled through the first cooling device 30a and then sequentially cooled through the second cooling device 30b. Since the first cooling device 30a is longer than the second cooling device 30b, the can 10 may be cooled for a longer time while passing through the first cooling device 30a.

The first cooling device 30a may include a first cooling water spraying unit 31a, a first nitrogen gas spraying unit 32a, a first foreign matter prevention unit 37a, a first water collecting unit 38a, a first adjusting bracket 40a, and a first fixing bracket 41a.

The first cooling water spraying unit 31a may include a first cooling water spraying pipe 33a and a first cooling water spraying nozzle 34a. The first nitrogen gas spraying unit 32a may include a first nitrogen gas spraying pipe 35a and a first nitrogen gas supply pipe 36a. The first water collecting unit 38a may include a first discharge unit 39a.

The second cooling device 30b may include a second cooling water spraying unit 31b, a second nitrogen gas spraying unit 32b, a second foreign matter prevention unit 37b, a second water collecting unit 38b, a second adjusting bracket 40b, and a second fixing bracket 41b.

The second cooling water spraying unit 31b may include a second cooling water spraying pipe 33b and a second cooling water spraying nozzle 34b. The second nitrogen gas spraying unit 32b may include a second nitrogen gas spraying pipe 35b and a second nitrogen gas supply pipe 36b. The second water collecting unit 38b may include a second discharge unit 39b.

The cooling water spraying unit 31 may include the first cooling water spraying unit 31a disposed on the entire first straight rail 51a along the traveling direction of the conveyor 50, and the second cooling water spraying unit 31b disposed on the entire second straight rail 51b.

The nitrogen gas spraying unit 32 may include the first nitrogen gas spraying unit 32a disposed at a rear end portion of the first straight rail 51a along the traveling direction of the conveyor 50, and the second nitrogen gas spraying unit 32b disposed on the entire second straight rail 51b.

That is, the cooling water spraying unit 31 may cool the outside of the can 10 during the entire process in which the can 10 is conveyed along the conveyor 50, and the second nitrogen gas spraying unit 32b may cool the inside of the can 10 during the entire process of being conveyed along the second straight rail 51b.

The first nitrogen gas spraying unit 32a may cool the inside of the can 10 during a partial process of being conveyed along the first straight rail 51a. The first nitrogen gas spraying unit 32a may cool the inside of the can 10 during a latter part of a process of being conveyed along the first straight rail 51a.

That is, the nitrogen gas spraying unit 32 may continuously cool the inside of the can 10 through the first nitrogen gas spraying unit 32a disposed at the rear end portion of the first straight rail 51a and the second nitrogen gas spraying unit 32b disposed on the entire second straight rail 51b.

The first nitrogen gas spraying unit 32a is disposed at the rear end portion of the first straight rail 51a, and may additionally cool the inside of the can 10 conveyed while being cooled through the first cooling water spraying unit 31a.

That is, the second nitrogen gas spraying unit 32b may be disposed together in an entire arrangement area of the second cooling water spraying unit 31b to simultaneously cool the inside and outside of the can 10, and the first nitrogen gas spraying unit 32a may be disposed together in a part of an arrangement area of the first cooling water spraying unit 31a to simultaneously cool the inside and outside of the can 10 during a partial process. However, it is not limited thereto.

The nitrogen gas spraying unit 32 of the apparatus 1 for manufacturing a carbonated beverage containing fruit pieces P according to the present invention is disposed at the rear end portion of the first straight rail 51a and the second straight rail 51b, thereby intensively cooling the inside of the can 10 containing the fruit pieces P before filling carbonated water containing carbon dioxide gas through the filler 60.

Accordingly, it is possible to secure a temperature of the can 10 capable of increasing solubility of carbon dioxide gas and preventing vaporization, and through this, it is possible to prevent generation of bubbles of carbonated water in a process of filling the carbonated water containing carbon dioxide gas into the can 10.

The first cooling device 30a may include three first adjusting brackets 40a and three first fixing brackets 41a respectively disposed to be spaced apart on both sides of the conveyor 50. The first cooling device 30a may include 128 first cooling water spraying nozzles 34a disposed to be spaced apart on both sides of the conveyor 50. However, it is not limited thereto.

The first cooling device 30a may include five first nitrogen gas spraying pipes 35a and one first nitrogen gas supply pipe 36a disposed to be spaced apart from each other. The first cooling device 30a may include two first discharge units 39a disposed to be spaced apart from each other. However, it is not limited thereto.

The second cooling device 30b may include two second adjusting brackets 40b and two second fixing brackets 41b respectively disposed to be spaced apart on both sides of the conveyor 50. The second cooling device 30b may include 50 second cooling water spraying nozzles 34b disposed to be spaced apart on both sides of the conveyor 50. However, it is not limited thereto.

The second cooling device 30b may include 11 second nitrogen gas spraying pipes 35b and two second nitrogen gas supply pipes 36b disposed to be spaced apart from each other. The second nitrogen gas spraying pipes 35b may be disposed to be spaced apart from each other at regular intervals, and the second nitrogen gas supply pipes 36b may be disposed at one end and the other end of the second straight rail 51b. The second cooling device 30b may include one second discharge unit 39b. However, it is not limited thereto.

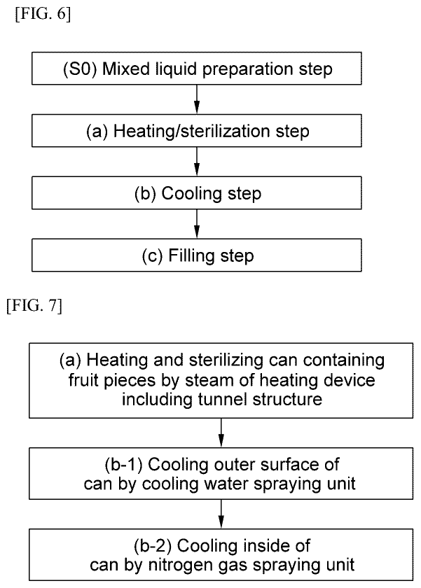

FIG. 6 is a view illustrating steps of a method for manufacturing a carbonated beverage containing fruit pieces according to the present invention. FIG. 7 is a view specifically illustrating a heating/sterilizing step and a cooling step in the method for manufacturing a carbonated beverage containing fruit pieces according to the present invention.

Hereinafter, a method for manufacturing a carbonated beverage containing fruit pieces according to the present invention will be described in detail with reference to FIGS. 1 to 7.

The method for manufacturing a carbonated beverage containing fruit pieces according to the present invention may include a mixed liquid preparation step S0, a heating/sterilizing step (a), a cooling step (b), and a filling step (c).

In the mixed liquid preparation step S0, raw materials may be dissolved in hot water and mixed according to a mixing ratio of mixing components. The mixed liquid may include a fruit flavor or a fruit fragrance corresponding to the fruit pieces P included therein. For example, when the fruit pieces P include lemon pieces, the mixed liquid may include at least one of erythritol, carbon dioxide, citric acid, lemon concentrate, trisodium citrate, vitamin C, sucralose, acesulfame potassium, lemon flavor, natural flavor, honey flavor, and purified water.

When the fruit pieces P include grapefruit pieces, the mixed liquid may include at least one of erythritol, carbon dioxide, citric acid, red grapefruit concentrate, trisodium citrate, vitamin C, sucralose, acesulfame potassium, quinine hydrochloride, grapefruit flavor, and purified water.

However, the present invention is not limited thereto, and the fruit pieces P may include various fruit pieces P such as pineapple pieces, lychee pieces, mango pieces, peach pieces, or grape pieces in addition to lemon pieces or grapefruit pieces.

The mixed liquid prepared by dissolving raw materials in hot water may be sterilized at 95° C. to 100° C. for 20 seconds to 60 seconds, cooled, and stored in a separate storage tank (not shown). Preferably, the mixed liquid may be sterilized at 98° C.±2° C. for 30 seconds, cooled, and stored in a storage tank (not shown).

In the heating/sterilizing step (a), the inside of the can 10 may be washed at a pressure of 1.0 kg/cm² or more, and the fruit pieces P may be put into the washed can 10.

When the fruit pieces P are fruit slices, a manufacturer may manually put the sliced fruit pieces P into the can 10. When the fruit pieces P are fruit cubes, the fruit pieces P being fruit cubes may be automatically put into the can 10 through a separate input device (not shown).

The fruit pieces P may be 2 to 3% by weight in a carbonated beverage including a mixed liquid containing the fruit pieces P and carbonated water. Preferably, the fruit pieces P may be included in the carbonated beverage in an amount of 2.85% by weight. However, it is not limited thereto.

The can 10 containing the fruit pieces P may be conveyed through the conveyor 50 and passed through the heating device 20 to heat-sterilize the can 10 containing the fruit pieces P.

The heating/sterilizing step (a) may include passing the can 10 containing the fruit pieces P through the heating device 20 having a tunnel structure at 90° C. to 95° C. for 10 minutes to 15 minutes to heat-sterilize using steam. Preferably, the can 10 containing the fruit pieces P may be heat-sterilized at 93° C.±2° C. for 10 minutes or more.

The method for manufacturing a carbonated beverage containing fruit pieces according to the present invention can kill microorganisms remaining in the fruit pieces P including raw fruit flesh as much as possible through the heating/sterilizing step (a).

The can 10 containing the fruit pieces P to be heated/sterilized may include an aluminum material. However, the present invention is not limited thereto, and the can 10 may include various materials that are heat-resistant to a temperature for heating/sterilizing the fruit pieces P included in the can 10 and are not deformed.

Meanwhile, when the carbonated beverage is a carbonated beverage containing alcohol such as whiskey, microorganisms present in the fruit pieces P may be sterilized by alcohol of the whiskey. Accordingly, in this case, a separate heating/sterilizing step (a) may be omitted.

By omitting the heating/sterilizing step (a), a manufacturing time of the carbonated beverage containing the fruit pieces P can be reduced, and since there is no need to have heat resistance to a temperature for heating/sterilizing the fruit pieces P included in the can 10, the can 10 may include a plastic material rather than an aluminum material.

In addition, the can 10 may include a transparent material so that the fruit pieces P included in the inside of the can 10 can be visually checked from the outside of the can 10. The can 10 may include a transparent plastic material.

In the cooling step (b), the can 10 containing the heat-sterilized fruit pieces P may be cooled through the cooling device 30. The can 10 containing the fruit pieces P conveyed through the conveyor 50 passing through the heating device 20 may be cooled through the cooling device 30.

The cooling step (b) may include a step (b-1) of spraying cooling water into the can 10 through the cooling water spraying unit 31, and a step (b-2) of spraying nitrogen gas into the can 10 through the nitrogen gas spraying unit 32.

The step (b-1) may include spraying cooling water onto an outer surface of the can 10 through the cooling water spraying unit 31, and the step (b-2) may include spraying nitrogen gas into the inside of the can 10 through the nitrogen gas spraying unit 32.

Step (b) may proceed from step (b-1), proceed with step (b-2) simultaneously while step (b-1) is in progress, and terminate step (b-1) and step (b-2) together.

That is, the can 10 containing the fruit pieces P conveyed along the straight rail 51 may be cooled by the cooling water spraying unit 31 during the entire conveying process, and may be additionally cooled by the nitrogen gas spraying unit 32 during a partial process.

Step (b) may include cooling the can 10 containing the fruit pieces P through the first cooling device 30a disposed on the first straight rail 51a, and cooling the can 10 containing the fruit pieces P through the second cooling device 30b disposed on the second straight rail 51b.

The method for manufacturing a carbonated beverage containing fruit pieces according to the present invention may lower a temperature of the can 10 containing the heated fruit pieces P through the cooling step (b), and prevent carbon dioxide gas of carbonated water filled into the can 10 through the filler 60 from being vaporized.

In the filling step (c), a mixed liquid containing carbonated water stored in a separate storage tank (not shown) may be injected into the can 10 containing the fruit pieces P cooled by the cooling device 30 through the filler 60.

In the filling step (c), the can 10 containing the fruit pieces P may be cooled through the second cooling device 30b until immediately before the filling step (c), and then the carbonated water may be filled through the filler 60. A carbon dioxide gas pressure of the filler 60 may be injected to fit a volume of 3.0±0.3. However, it is not limited thereto.

In the method for manufacturing a carbonated beverage containing fruit pieces according to the present invention, by proceeding with the filling step (c) after the cooling step (b), it is possible to prevent bubbles that may be generated when filling the carbonated water containing carbon dioxide gas and the mixed liquid into the inside of the can 10, thereby preventing the filled mixed liquid and the like from overflowing to the outside of the can 10 when sealing the product after filling. Accordingly, a filling speed through the filler 60 may be improved, and productivity of a product may be significantly increased.

The can 10 containing the fruit pieces P having passed the filling step (c) may be heated to about 40° C. by passing through a heating tunnel (not shown), data coding such as an expiration date may be stamped, a weight of a product may be checked and whether or not there is an abnormality may be inspected, and a product without abnormality may be packaged and shipped.

Although the technical spirit of the present invention as described above has been described by specific embodiments, the scope of the present invention is not limited to these embodiments.

Various embodiments that can be modified or changed by those skilled in the art without departing from the gist of the technical spirit of the present invention specified in the claims will also fall within the scope of the present invention.

### REFERENCE NUMERALS

1: Apparatus for manufacturing carbonated beverage 10: Can
20: Heating device 30: Cooling device
30a: First cooling device 30b: Second cooling device
31: Cooling water spraying unit 32: Nitrogen gas spraying unit
33: Cooling water spraying pipe 34: Cooling water spraying nozzle
35: Nitrogen gas spraying pipe 36: Nitrogen gas supply pipe
37: Foreign matter prevention unit 38: Water collecting unit
39: Discharge unit 40: Adjusting bracket
41: Fixing bracket 50: Conveyor
51: Straight rail 51a: First straight rail
51b: Second straight rail 52: Curved rail
52a: First curved rail 52b: Second curved rail
60: Filler P: Fruit piece

What is claimed is:

1. An apparatus for manufacturing a carbonated beverage containing fruit pieces, comprising: a heating device configured to heat-sterilize a can containing fruit pieces;
a cooling device configured to cool the can having passed through the heating device; and
a filler configured to inject carbon dioxide gas into the can having passed through the cooling device, wherein
the cooling device includes:
a cooling water spraying unit configured to spray cooling water onto the can; and
a nitrogen gas spraying unit configured to spray nitrogen gas into the can.

2. The apparatus of claim 1, wherein
the cooling water spraying unit is configured to spray cooling water to an outside of the can, and wherein
the nitrogen gas spraying unit is configured to spray nitrogen gas into an inside of the can.

3. The apparatus of claim 2, wherein
the cooling water spraying unit includes a plurality of cooling water spraying pipes respectively disposed along a traveling direction of a conveyor near both sides of the conveyor conveying the can so as to cool both side surfaces of the can, and wherein
the plurality of cooling water spraying pipes include a plurality of cooling water spraying nozzles disposed to be spaced apart along the traveling direction of the conveyor.

4. The apparatus of claim 3, wherein
the nitrogen gas spraying unit includes a nitrogen gas spraying pipe disposed at an upper portion of the can conveyed along the conveyor so as to cool the inside of the can.

5. The apparatus of claim 1, wherein
the heating device includes a tunnel structure configured to heat-sterilize the can containing the fruit pieces introduced into and discharged from the heating device using steam.

6. The apparatus of claim 3, wherein
the cooling device further includes a foreign matter prevention unit disposed at an upper portion of the conveyor so as to prevent foreign matter from penetrating into an inside of the can, and wherein
the foreign matter prevention unit is disposed to be connected to both side surfaces of the nitrogen gas spraying unit along the traveling direction of the conveyor.

7. The apparatus of claim 3, wherein
the cooling device further includes a water collecting unit disposed at a lower portion of the conveyor so as to store the cooling water sprayed from the cooling water spraying unit, and wherein
the water collecting unit includes a discharge unit configured to discharge the cooling water stored in the water collecting unit to a lower portion of the water collecting unit.

8. The apparatus of claim 3, wherein
the cooling water spraying unit further includes a plurality of adjusting brackets disposed on both sides of the conveyor so as to adjust heights of the plurality of cooling water spraying pipes according to a height of the can.

9. The apparatus of claim 3, wherein
the conveyor includes a straight rail and a curved rail extending from the straight rail, and wherein
the cooling device is disposed along the straight rail.

10. The apparatus of claim 9, wherein
the straight rail includes a first straight rail connected to the heating device, and a second straight rail disposed to be spaced apart from the first straight rail along the traveling direction of the conveyor, and wherein
the cooling device further includes:
a first cooling device disposed on the first straight rail; and
a second cooling device disposed on the second straight rail and having a length shorter than a length of the first cooling device along the traveling direction of the conveyor.

11. The apparatus of claim 10, wherein
the nitrogen gas spraying unit includes:
a first nitrogen gas spraying unit disposed at a rear end portion of the first straight rail along the traveling direction of the conveyor; and
a second nitrogen gas spraying unit regularly disposed on the second straight rail.

12. A method for manufacturing a carbonated beverage containing fruit pieces, comprising:
(a) conveying a can containing the fruit pieces through a conveyor and passing the can through a heating device to heat-sterilize the fruit pieces;
(b) cooling the can containing the heat-sterilized fruit pieces through a cooling device; and
(c) injecting a mixed liquid containing carbonated water into the can containing the cooled fruit pieces through a filler.

13. The method of claim 12, wherein
step (a) comprises passing the can containing the fruit pieces through the heating device at 90° C. to 95° C. for 10 minutes to 15 minutes to heat-sterilize the can using steam.

14. The method of claim 12, wherein
step (b) comprises:
(b-1) spraying cooling water onto an outer surface of the can through a cooling water spraying unit; and
(b-2) spraying nitrogen gas into an inside of the can through a nitrogen gas spraying unit.

15. The method of claim 14, wherein
step (b) comprises:
proceeding with step (b-1), adding step (b-2) while step (b-1) is in progress to proceed with step (b-1) and step (b-2) simultaneously, and
terminating step (b-1) and step (b-2) together.

16. The method of claim 14, wherein
step (b) comprises:
cooling the can containing the fruit pieces through a first cooling device; and
cooling the can containing the fruit pieces through a second cooling device disposed to be spaced apart from the first cooling device along the traveling direction of the conveyor.

17. A carbonated beverage comprising:
fruit pieces including raw fruit flesh;
a can configured to accommodate the fruit pieces; and
a mixed liquid containing carbon dioxide gas filled into the can containing the fruit pieces, wherein
the fruit pieces are cooled to prevent the carbon dioxide gas of the mixed liquid filled into the can from being vaporized.

18. The carbonated beverage of claim 17, wherein
the mixed liquid includes alcohol to sterilize the fruit pieces contained in the can, and wherein
the can comprises a transparent plastic material.

19. The carbonated beverage of claim 17, wherein
the fruit pieces are heated and then cooled to sterilize microorganisms remaining in the fruit pieces, and wherein
the can containing the heated and cooled fruit pieces comprises an aluminum material.

20. The carbonated beverage of claim 17, wherein
the fruit pieces are 2 to 3% by weight.
